(19) United States
(12) Patent Application Publication
(10) Pub. No.: US 2026/0289332 A1
(43) Pub. Date: Sep. 24, 2026

(54) SEMANTIC PROGRESSION LAYER FOR GRAPH-STRUCTURED DATA

(71) Applicant: Sam Malayeksefat, Toronto (CA)

(72) Inventor: Sam Malayeksefat, Toronto (CA)

(21) Appl. No.: 19/658,690

(22) Filed: Apr. 26, 2026

Related U.S. Application Data
(63) Continuation of application No. 19/418,990, filed on Dec. 14, 2025.

(51) Int. Cl. G06N 5/02

(52) U.S. Cl. CPC G06N 5/02

(57) ABSTRACT

A graph-based semantic progression layer for generating recommendations and other progression-related outputs is disclosed. A base knowledge graph is initialized and populated with content from multiple sources. User input and user-specific data are collected and mapped onto the base graph to form a superposed per-user familiarity graph. Paths are drawn from one or more root nodes according to a dimension of interest (e.g., prerequisites or difficulty). Three disjoint regions are identified relative to the user's paths: a forward region of advanced content, a skipped region of unmet prerequisites, and a lateral region of nearby breadth topics. Candidates from these regions are ranked using goal similarity, coverage gain, familiarity, and redundancy to produce personalized recommendations that adapt over time to the user's evolving goals and mastery. Region membership is stored as efficiently updatable bitsets and incrementally maintained in response to user events, reducing recomputation overhead on large graphs.

### FIELD OF THE INVENTION

The present invention relates generally to data modelling and graph-structured representations, and more particularly to computer-implemented systems and methods for organizing user progression, familiarity, and context within graph-structured data to produce adaptive progression-related constructs and outputs, including recommendations or structured guidance.

### BACKGROUND OF THE INVENTION

Existing systems that utilize graph-structured data often surface items primarily through direct correlations, proximity, or local similarity within the graph. These systems typically lack mechanisms for computing and/or maintaining an explicit per-user progression layer that models a user's evolving familiarity, progression, or mastery across multi-level structures. Even when contextual or multi-source data is incorporated, conventional approaches generally emphasize retrieving or ranking locally related items rather than modelling a user's position, gaps, eligibility, or potential paths through a broader semantic structure.

By contrast, the present invention models user state relative to a graph-structured representation of topics, skills, or content and derives progression-related constructs from that state, including region memberships and other progression-layer representations. Such constructs may reflect, for example, what a user may be prepared to advance toward, what foundational material may be incomplete, or what adjacent areas may broaden understanding. The semantic progression layer may be consumed by one or more downstream components to generate progression-related outputs, including recommendations, ranked content lists, guided navigation, visualizations, or structured guidance.

### SUMMARY OF THE INVENTION

In some embodiments, the present disclosure provides a semantic progression layer implemented over a base graph data structure. The system computes user-specific signals such as familiarity, relevance, or goal alignment, superposes these signals onto the graph, and derives progression-related constructs relative to one or more dimensions of interest. In one embodiment, these constructs include at least three pairwise disjoint regions corresponding to forward, skipped, and lateral areas. In other embodiments, the same underlying signals are used to compute a unified scoring representation or other progression-related constructs from which region membership, candidate sets, or ordered sequences may be derived. In still other embodiments, the semantic progression layer operates in a mastery-gated mode in which prerequisite constraints are enforced as graph constraints and user state is modelled as a mastery score per node with gated eligibility, and progression-related outputs are optimized for mastery gain and pacing rather than region membership. In yet other embodiments, the semantic progression layer is implemented as a continuous curriculum field or potential field over the graph, wherein each node is assigned a scalar value reflecting relevance, urgency, or expected mastery gain, and progression-related outputs follow gradients of that field rather than selecting from discrete region sets. In further embodiments, each node stores a plurality of dimension-of-interest values and progression is modelled as movement along a multi-dimensional surface; a Pareto-efficient frontier of candidate nodes may be computed and represented as a frontier bitset whose set bits indicate non-dominated nodes across the dimensions. In still further embodiments, the system maintains uncertainty estimates over mastery, selects diagnostic items to maximize expected information gain, and/or applies graph-constrained bandit or reinforcement-learning policies that trade off exploration and exploitation subject to prerequisite gating encoded in eligibility bitsets, and aggregates per-user bitsets to form cohort-level overlays and objectives. By maintaining per-user and per-cohort progression regions, frontier bitsets, and eligibility bitsets as incrementally updatable data structures rather than recomputing membership from the full graph on every request, the system reduces processor cycles, memory bandwidth, and random access operations needed to serve progression-layer constructs at graph sizes for which naive per-node recomputation is infeasible. One or more downstream components may consume the progression-layer constructs to generate adaptive outputs, including recommendations, ranked content lists, structured guidance, visualizations, navigation flows, schedules, or other progress-oriented responses.

In some embodiments, the user input may include, for example, personal preferences, goals, constraints, and contextual information.

In some embodiments, the data collected from the plurality of sources may comprise: for example, web crawling the internet, mining social media platforms, or accessing other internet platforms.

In some embodiments, the user-specific data to populate the superposed graph may include professional, financial, health, educational, or other contextual data, as well as any relevant interactions from social or online platforms.

The method may additionally include updating, by the system, the outputs of the semantic progression layer whenever the user logs in or accesses the system, allowing downstream components (e.g., recommendation or guidance modules) to recalibrate based on new data or updated user context.

In some embodiments, the semantic progression layer improves operation of the underlying computer system by addressing a technical scaling problem: maintaining per-user progression constructs over a large graph without repeatedly performing full-graph traversals and per-node recomputation in response to user events. The disclosed system persists region membership as compact, word-addressable region bitsets keyed by stable node identifiers and maintains an invariant that the forward, skipped, and lateral region bitsets are pairwise disjoint. When user events occur (e.g., an accepted recommendation, assessment completion, or other interaction), the system identifies a limited set of affected nodes and computes a bounded local neighborhood around those affected nodes; the system then applies delta writes that set and clear bit positions only for node identifiers in that neighborhood. This localized bitset maintenance reduces processor cycles, memory bandwidth consumption, and random memory accesses relative to recomputation across all nodes of the knowledge graph, and enables low-latency serving of progression-layer constructs and downstream outputs at graph sizes for which naive recomputation is impractical.

In another aspect, the present disclosure relates to a system associated with a digital platform, wherein the system may include a memory to store instructions and a processor in communication with the memory. The processor may be configured to execute the instructions to initialize a base graph data structure prior to any user input, populate the graph with data from a plurality of sources, receive a user input from a user device associated with the user, collect data from various sources corresponding to the user, generate a superposed graph of paths for consumed or familiar content, and compute at least three progression-related regions and related progression-layer constructs for the user—by way of example, a forward-looking region, a backward-looking or “skipped” region, and a third region covering lateral or unexplored areas in relation to the user's superposed paths. In some embodiments, these regions and/or other progression-layer constructs are consumed by one or more downstream components to generate progression-related outputs, including recommendations or guidance.

In another aspect, the present disclosure relates to a non-transitory computer-readable storage medium comprising instructions executable by a processor, the instructions to cause the processor to carry out any of the methods disclosed herein.

These and other objects, features, and advantages of the present disclosure-such as providing a structured, goal-oriented semantic progression layer that can produce and/or provide progression-layer constructs for use by downstream components to generate adaptive outputs including recommendations, structured guidance, ranked lists, or guided navigation-will become more readily apparent from the attached drawings and from the detailed description of certain illustrative embodiments, which follow.

### BRIEF DESCRIPTION OF THE DRAWINGS

The accompanying drawings, which are incorporated herein and constitute a part of the present disclosure, illustrate exemplary embodiments of the disclosed methods and systems. The components in the drawings are not necessarily to scale, with emphasis instead placed upon clearly illustrating the principles of the present disclosure. Like reference numerals refer to the same parts throughout the different drawings.

FIG. 1 depicts an example networked environment, in accordance with some embodiments of the present disclosure, in which multiple data sources, user devices, and a system can communicate via a communication network.

FIG. 2 shows a block diagram of an exemplary system associated with a digital platform, including processor 202, memory 204, interfaces 206, client devices 212, data stores 210A-210C, and a semantic progression engine 208 comprising modules 208-1 through 208-6.

FIG. 3 illustrates an example representation of a base knowledge graph and a superposed per-user familiarity graph, highlighting progression-related regions (forward, backward, and lateral) as discussed herein usable for recommendations or other outputs.

FIG. 4 is a flowchart of an example method for initializing and producing a versioned base knowledge graph: provisioning data stores; registering sources; ingesting raw content; canonicalizing tags/keywords; computing features and typed edges; clustering and validation; persisting a versioned snapshot; and exposing read interfaces for downstream components.

FIG. 5 depicts an exemplary computer system that may be used to implement or support the disclosed methods and systems, illustrating processor(s), memory, external storage, and communication port(s).

FIG. 6 illustrates a cold-start progression-layer initialization/progression-layer update workflow in which the system computes the familiar set, derives the forward, skipped, and lateral regions, and ranks candidates per the definitions and equations described herein.

FIG. 7 illustrates an incremental update workflow following a user action, including delta-updating the user backbone and disjoint region bitsets and re-ranking only affected candidates.

The foregoing, together with the following detailed description, will provide a thorough understanding of the methods, systems, and computer-readable media disclosed herein.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

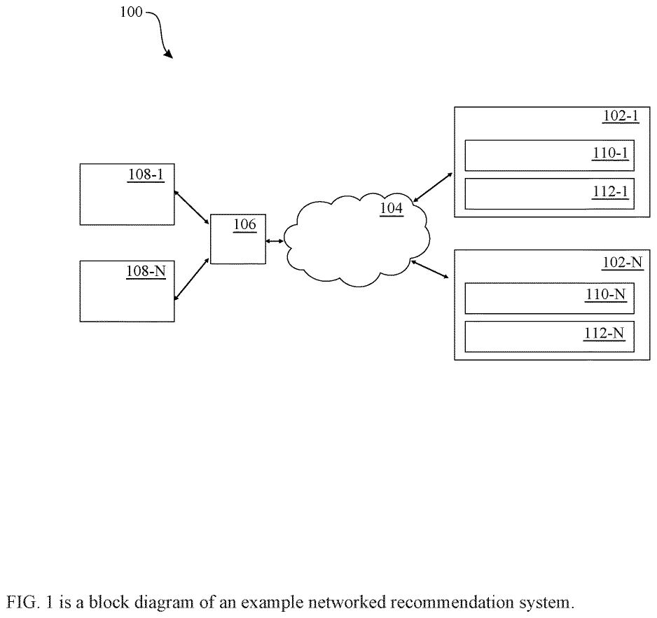

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its broadest sense that is as meaning “and/or” unless the content clearly dictates otherwise.

The headings and Abstract of the Disclosure provided herein are for convenience only and do not interpret the scope or meaning of the implementations.

Definitions—graph primitives. A base knowledge graph G=(V, E) stores content nodes V and typed edges E (including at least prerequisite, part-of, and similarity edges). A “root” node has no incoming prerequisite edge. A “path” is an ordered sequence of nodes connected by edges of a common type.

Dimension of Interest/DoI. A dimension of interest (DoI) is an ordered node attribute d defined over V (e.g., prerequisite depth, difficulty level, curriculum level, or time sequence). Node a precedes node b on DoI d if d(a)<d(b) and there is a path, using edges typed for d, that connects a to b.

Familiarity score. For user u and node n, a familiarity score F(u, n) is computed by weighting consumption, assessment, and dwell-time signals, applying a recency-decay factor, and bounding the result to [0, 1]. A node is “familiar” for user u when F(u, n)≥τ. In one example,

$$F ( u , n ) = clip ( α \cdot consumption ( u , n ) + β \cdot assessment ( u , n ) + γ \cdot dwell ( u , n ) ) \cdot ρ ( Δ t ) ,$$

where ρ(Δt)=exp(−λ·Δt), Δt denotes elapsed time since the user's most recent interaction with node n, and α, β, γ, λ, and tare tunable parameters. As used in the claims, τ (tau) denotes the familiarity threshold and δ (delta) denotes the lateral tolerance.

Superposed per-user graph. A superposed graph G_u overlays the base graph with the user's familiar nodes S_u={n in V|F(u, n)≥τ} and the minimal connecting prerequisite paths between S_u and one or more root nodes.

Path direction. As used herein, “drawing one or more paths from one or more root nodes” includes generating paths by (i) forward traversal starting at a root node, and/or (ii) reverse traversal from a user-familiar node to a root node along directed prerequisite edges, where the reverse traversal yields the same ordered path when read in reverse.

Region definitions. Relative to G_u and DoI d:
(i) Forward region: nodes reachable from any familiar node by a path with strictly increasing values of d, excluding familiar and skipped nodes.
(ii) Skipped region: nodes that precede at least one familiar node on d and are not familiar (i.e., F(u, n)<τ).
(iii) Lateral region: nodes within k hops of any familiar node whose DoI differs by at most δ, i.e., |d(n)−d(s)|≤δ, excluding familiar, forward, and skipped nodes.

Terminology; synonyms. As used herein, the terms “forward” and “ahead” are used interchangeably to refer to progression-related nodes beyond a user's current familiarity along a selected dimension of interest. Similarly, “skipped” and “backward-looking” (or “backward”) are used interchangeably to refer to prerequisite or preceding nodes not detected among the user's visited or consumed content. “Lateral” may also be referred to as “adjacent” and refers to nodes that broaden exploration relative to explored regions. These terms are used for clarity of explanation and do not limit the scope of the disclosure.

Disjointness; stored representation. In some embodiments, the forward region, skipped region, and lateral region are computed and maintained as pairwise disjoint regions for deterministic presentation and auditability. In one implementation, disjointness is enforced by an exclusion precedence: (i) compute the skipped set; (ii) compute the forward set while excluding skipped nodes and familiar nodes; and (iii) compute the lateral set while excluding familiar nodes and excluding the union of skipped and forward nodes. In certain embodiments, region membership is stored as three bitsets over a stable node-identifier space (FWD[u], SKIP[u], LAT[u]) that satisfy the pairwise-disjointness invariants:

$$FWD [ u ] ∩SKIP [ u ] = ∅ ; FWD [ u ] ∩LAT [ u ] = ∅ ; and SKIP [ u ] ∩LAT [ u ] = ∅ .$$

In such embodiments, when a node satisfies criteria for multiple regions, the node is assigned to exactly one region according to the exclusion precedence.

Although certain embodiments describe progression using three discrete and pairwise-disjoint regions, other embodiments may represent progression using continuous scores, weighted factors, or unified ranking functions derived from user-specific signals. In such embodiments, discrete regions may be computed as a view, partition, or interpretation of an underlying continuous representation, and implementations may present either discrete sets, continuous gradients, or unified ranked sequences. These variations remain consistent with the underlying semantic progression layer and are within the scope of the present disclosure.

Notation. Let G=(V, E) be the base knowledge graph with a dimension of interest d: V→R (e.g., prerequisite depth or difficulty), where R denotes the set of real numbers. For user u and node n, familiarity F(u,n) is in [0,1]. Threshold τ defines familiarity; k in N is a hop limit; δ is a lateral tolerance used only in the lateral membership test. Define Δd(n,s)=|d(n)−d(s)|. A “root” has no incoming prerequisite edge. “Familiar” means F(u,n)≥τ. N denotes the non-negative integers. For any node x∈V, prereqs(x)⊆V denotes the set of immediate prerequisite nodes of x, i.e., {p∈V:(p,x)∈E and the edge is typed “prerequisite” }. Unless stated otherwise, coverage_gain(⋅) in Eq. (2) is computed with respect to prereqs(x). In some embodiments, a transitive prerequisite closure (e.g., prereqs_plus(x)) may be used instead; references to prereqs(x) herein are to the immediate set unless explicitly noted.

### Equation (1)—Familiarity.

Let cons(u,n), verify(u,n), and dwell(u,n) be normalized signals, where verify encompasses any measurable evidence of comprehension (e.g., task outcomes, reviews, spaced-repetition results, or quizzes). Let ρ(Δt)=exp(−λ−Δt) be a recency decay (λ≥0). With clip(⋅) bounding to [0,1]:

$$F ( u , n ) = clip ( α \cdot cons + β \cdot verify + γ \cdot dwell ) \cdot ρ ( Δ t ) , with α , β , γ \geq 0.$$

(Setting any weight to 0 disables that signal—e.g., β=0 removes quizzes/verification entirely.)

### Equation (2)—Ranking.

For candidate x:

$$R ( x ) = L1goal\_sim ( x , G\_u ) + L2coverage\_gain ( x ) + L 3 * ( 1 - F ( u , x ) ) - L 4 * redundancy ( x ) ,$$

where coverage_gain(x)=|prereqs(x)∩S_u|/max(1, |prereqs(x)|), i.e., the fraction of x's prerequisites that are already satisfied by the user's familiar set/backbone.

Multi-dimensional dimensions of interest. In some embodiments, progression is defined with respect to a plurality of dimensions of interest rather than a single scalar. For node n, a dimension-of-interest vector d^{→}(n)=(d₁(n), d₂(n), . . . , d_m(n)) is stored, where each component d_j(n) is an ordered attribute such as difficulty, time cost, curriculum level, exam relevance, or prerequisite depth. A node a is said to dominate node b if, for all j, d_j(a) d_j(b) and for at least one j, d_j(a)<d_j(b), assuming smaller values correspond to more favorable progression along the j-th dimension. A node is Pareto-efficient or non-dominated if no other node in a candidate set dominates it. In some embodiments, a scalar dimension of interest d(⋅) is still used for region definitions, while d^{→}(⋅) is used to compute multi-dimensional frontiers for selection and visualization.

### Equation (3)—Multi-Dimensional Domination; Scalar Projection.

In multi-dimensional embodiments, each node n has a dimension-of-interest vector d^{→}(n)=(d₁(n), . . . , d_m(n)) as described above. For two nodes a and b in a candidate set C, a is said to [symbol] dominate b (denoted a [symbol] b) if:

$$d\_j ( a ) \leq d\_j ( b ) for all j ∈ \{ 1 , … , m \} and$$

$$d\_k ( a ) < d\_k ( b ) for at least one k .$$

In some embodiments, a scalar projection score P(n) is additionally computed from d^{→}(n) to order or band nodes on the frontier, for example:

$$P ( n ) = {\sum }_{j} {w}_{j} \cdot d\_j ( n ) ,$$

where wⱼ≥0 are configuration weights that may be learned or manually specified. Non-dominated nodes form a Pareto frontier; P(n) is used only for tie-breaking or presentation and does not alter the definition of domination.

Frontier bitset; candidate bitset; dimension score arrays. In multi-dimensional embodiments, a frontier bitset FRONT[u] is allocated per user as a bitset over V, where a set bit at position i indicates that the node with stable identifier i is on a Pareto-efficient frontier for that user. A candidate bitset CAND[u] is used to represent an intermediate candidate set for frontier computation. For each dimension of interest d_j, the system stores a dimension-specific score array scores_j indexed by node identifier, holding the value d_j(n) for each n∈V. Pareto-frontier computation may proceed by iteratively selecting pivot nodes from CAND[u], comparing their dimension score vectors against other candidates using the score arrays, and clearing dominated nodes via bitwise AND-NOT operations until convergence.

Uncertainty estimate; diagnostic candidate bitset; information gain. In some embodiments, in addition to familiarity or mastery scores, the system maintains an uncertainty estimate U(u, n) for user u and node n. The uncertainty estimate may be implemented as a variance parameter σ²(u, n) associated with the mastery score, as an entropy value over a discrete proficiency distribution, or as another scalar dispersion measure. A diagnostic candidate bitset DIAG[u] is maintained per user, containing one bit per node identifier; bits set in DIAG[u] mark nodes that are eligible to be used as diagnostic items. An expected information gain value IG(u, n) is computed for each node with DIAG[u] bit set, representing an expected reduction in global uncertainty (for example, a decrease in the sum of uncertainty estimates across nodes) given possible assessment outcomes at node n.

### Equation (4)—Expected Information Gain.

In diagnostic mode, for user u and node n, an expected information gain value IG(u, n) is computed from possible assessment outcomes o∈Ω (e.g., correct/incorrect or discrete score levels). Let p(o|u, n) denote the system's current estimate of the probability of outcome o for user u at node n, and let U_total(u) denote a global uncertainty metric for user u (for example, the sum of variances or entropies across a set of tracked nodes). Let U_total′(u|o, n) denote the updated uncertainty metric that would result if outcome o were observed at node n. One implementation defines:

$$IG ( u , n ) = \sum \_ \{ o ∈ Ω \} p ( o \vert u , n ) \cdot [ U\_total ( u ) - {U\_total}^{′} ( u \vert o , n ) ] .$$

Nodes with higher IG(u, n) are preferred as diagnostic candidates because they are expected to reduce global uncertainty more per diagnostic interaction.

Reward estimate; eligibility bitset; exploration bonus. In exploration-exploitation embodiments, each node n (or each group of nodes) is associated with a reward estimate \hat{R}(u, n) for user u, representing an expected outcome such as mastery gain, engagement, or satisfaction. A per-user eligibility bitset ELIG[u] contains one bit per node identifier and encodes graph-constrained gating conditions; a bit is set in ELIG[u] when the corresponding node satisfies prerequisite constraints, mastery thresholds, and any policy filters. A selection score S(u, n) is computed as a function of the reward estimate and an exploration bonus term B(u, n), such as S(u, n)=\hat{R}(u, n)+κ·B(u, n), where κ≥0 is a tunable exploration weight and B(u, n) may depend on the number of times node n has been recommended or on posterior uncertainty in \hat{R}(u, n).

### Equation (5)—Exploration-Exploitation Selection Score.

In exploration-exploitation embodiments, for user u and node n the system maintains a reward estimate \hat{R}(u, n) and a visitation count count(u, n) indicating how many times n has been selected. A selection score S(u, n) may be computed as:

$$S ( u , n ) = \hat{R} ( u , n ) + κ \cdot √ ( ln T ( u ) / ( 1 + count ( u , n ) ) ) ,$$

where κ≥0 is an exploration weight and T(u) denotes the total number of recommendation rounds performed so far for user u. The second term provides an exploration bonus that decays as count(u, n) increases. Other exploration bonus forms (e.g., Thompson sampling scores or posterior-variance terms) may be used in place of the square-root expression without departing from the scope of this disclosure.

Cohort-level region bitsets and objectives. In some embodiments, users are grouped into cohorts C⊆Users. For each user u∈C, user-specific region bitsets FWD[u], SKIP[u], and LAT[u] are maintained as described above. Cohort-level region bitsets are computed via bitwise aggregation, such as a cohort-union bitset FWD_union[C] whose bits are set when at least one user in the cohort has the corresponding bit set in FWD[u], and a cohort-intersection bitset FWD_intersect[C] whose bits are set when all users in the cohort have the corresponding bit set. Similar unions and intersections may be defined for SKIP and LAT. A cohort-level objective function J_C may be defined in terms of coverage of forward-region nodes, reduction of skipped-region nodes, and reduction of variance of mastery or familiarity across cohort members for nodes represented in the cohort-level bitsets.

### Equation (6)—Cohort-Level Objective.

For a cohort C of users and a set of nodes of interest V′⊆V, a cohort-level objective J_C may be defined in terms of skipped-region coverage and mastery variance. Let SKIP_union[C] denote a cohort-level skipped bitset as described herein, and let 1_{SKIP_union[C]}(n) be an indicator that is 1 when the bit for node n is set and 0 otherwise. Let M(u, n) be a mastery score for user u and node n, and let Var_C(n) be the variance of M(⋅, n) across u∈C. One example objective to be minimized is:

$$J\_C = α \cdot \sum \_ \{ n ∈ {V}^{′} \} 1 \_ \{ SKIP\_union [ C ] \} ( n ) + β \cdot \sum \_ \{ n ∈ {V}^{′} \} Var\_C ( n ) ,$$

where α, β≥0 are tunable weights. Recommendations that reduce J_C by decreasing the number of skipped nodes and/or reducing mastery variance across the cohort are preferred.

### Operational Definitions.

Def. D1 (Familiar set). S_u={n in V:F(u,n)≥τ} using Eq. (1).

Def. D2 (DoI & tunables). Inputs include: (i) the chosen dimension of interest d, threshold r, hop limit k, and lateral tolerance δ; (ii) familiarity weights alpha, beta, gamma and the recency-decay parameter lambda for Eq. (1); and (iii) ranking weights L1 . . . L4 and the Top-K value for Eq. (2). Any signal (e.g., verification/quizzes) may be disabled by setting its weight to zero; recency decay may be disabled by lambda=0. Implementations may choose the functional form of ρ(Δt) (e.g., exponential) and default values.

Def. D3 (Backbone). For each s in S_u, select a shortest path along prerequisite edges to a root; store the union of such paths as the user backbone. (One implementation uses Dijkstra over prerequisite edges with complexity O(|E| log |V|).)

Def. D4 (Region membership). Relative to S_u and d:
(i) SKIP: nodes that precede at least one familiar node on d and are not Familiar.
(ii) FWD: nodes reachable from any familiar node by a path with strictly increasing d, excluding Familiar and SKIP.
(iii) LAT: nodes within k hops of any familiar node with Δd(n,s)≤δ, excluding Familiar and the union of SKIP and FWD.

Def. D5 (Vantage/Current). Let CUR denote the current vantage node v selected in the UI. CUR is an anchor (not a region). Region membership (SKIP, FWD, LAT) remains pairwise disjoint; CUR may coincide with a node in any region or outside all regions.

Parallel computation and reconciliation. In some implementations, candidate supersets are computed in parallel from a consistent snapshot of (i) the familiar set S_u, (ii) the dimension of interest d(⋅), and (iii) the base knowledge graph: SKIP* (a superset of prerequisite/preceding candidates), FWD* (a superset of forward candidates reachable under increasing d), and LAT* (a superset of lateral candidates satisfying hop and tolerance criteria). After parallel discovery, pairwise disjointness is enforced by reconciliation to yield the same result as the exclusion-precedence evaluation:

$$SKIP = {SKIP}^{*} ∖ S\_u ; \\ FWD = {FWD}^{*} ∖ ( S\_u ⋃ SKIP ) ; and \\ LAT = {LAT}^{*} ∖ ( S\_u ⋃ SKIP ⋃ FWD ) .$$

In bitset implementations, these subtractions are performed using block-wise AND-NOT operations.

### Stored Representation & Disjointness.

Inv. I1 (Pairwise disjointness). Region membership may be persisted as three region bitsets over V (FWD[u], SKIP[u], LAT[u]) satisfying: (i) FWD[u]∩SKIP[u]=Ø; (ii) FWD[u]∩LAT[u]=Ø; and (iii) SKIP[u]∩LAT[u]=0. In certain embodiments, disjointness is enforced by computing SKIP first, then computing FWD excluding (SKIP U Familiar), and then computing LAT excluding (SKIP U FWD U Familiar).

Example implementation of region bitsets. In one embodiment, each region bitset (e.g., FWD[u], SKIP[u], LAT[u]) is implemented as a contiguous array of machine words (e.g., 64-bit integers), where each bit position corresponds to a stable node identifier in V. Setting a bit marks the corresponding node as a member of the region; clearing a bit removes membership. Bitwise AND, OR, and AND-NOT operations over the arrays are used to intersect and subtract sets. In other embodiments, compressed bitset formats (e.g., Roaring bitmaps) or sharded bitsets may be used; the specific representation is not limiting.

Distributed implementations. The functional blocks shown in the figures (e.g., 202, 204, 206, 208-1 . . . 208-6, 210A-210C, 214) may execute on a single machine or be distributed across multiple machines, containers, availability zones, or geographic regions, communicating over one or more networks. Data stores (210A-210C) may be partitioned, sharded, or replicated with strong or eventual consistency. The event bus (214) may be any publish/subscribe or log-based system. References to “a processor,” “a memory,” or “a store” include one or more such elements; references to “module,” “engine,” or “service” encompass processes, services, or microservices deployed together or separately.

Semantic progression layer. As used herein, a “semantic progression layer” refers to the combination of (i) a base graph G populated with nodes and typed edges, (ii) user-specific familiarity signals and overlays (e.g., G_u, S_u, and any backbones), and (iii) progression-related constructs derived from these signals, such as region memberships, continuous scores, or unified ranking functions. The semantic progression layer may be consumed by downstream components, including but not limited to recommendation modules, visualization interfaces, LLM-backed assistants, and study-planning tools. As used herein, a ‘knowledge graph’ includes any graph-structured representation of topics, skills, content, entities, or relationships, and is not limited to any particular data model or storage system.

In some embodiments, the semantic progression layer is an intermediate computational layer that maintains per-user progression state over a base knowledge graph and exposes progression-related constructs (e.g., region memberships, eligibility sets, frontier sets, continuous scores, or ranked candidate sets) to one or more downstream components. Downstream components may generate recommendations, guidance, visualizations, navigation paths, schedules, assessments, or other outputs based at least in part on the progression-related constructs.

Mastery score; gating. In some embodiments, progression is modelled via a mastery score M(u, n) for user u and node n. The mastery score M(u, n) is updated from assessment events, quiz outcomes, or other verification signals using a rating update rule (e.g., an Elo-style update) of the form:

$${M}^{′} ( u , n ) = M ( u , n ) + η \cdot ( s - E [ M ( u , n ) ] ) ,$$

where η is a learning rate, s is an observed outcome score, and E[M(u, n)] is an expected performance estimate.

A prerequisite-gating function g(u, x) is defined for candidate node x, where g(u, x)=1 if, and only if, all prerequisite nodes p in prereqs(x) satisfy M(u, p)≥θ, for a mastery threshold θ, and g(u, x)=0 otherwise. In mastery-gated embodiments, only nodes x with g(u, x)=1 are eligible for recommendation or activation.

Mastery-oriented objective; pacing schedule. In mastery-centric embodiments, the system defines an objective function J over a sequence of recommended nodes (x₁, . . . , x_T) that accounts for expected mastery gain per unit time, such as:

$$J = {\sum }_{t} Δ M ( u , {x}_{t} ) \text{/cost} ( {x}_{t} ) ,$$

where ΔM(u, xₜ) denotes an expected increase in mastery from engaging with xₜ and cost(xₜ) denotes an estimated time or effort cost. A pacing schedule P(u, t) specifies, for time intervals t, a subset of nodes or topics allocated to those intervals, subject to the prerequisite-gating function g(u, ⋅) and time or workload constraints.

Curriculum field/potential function. In some embodiments, progression is represented as a scalar curriculum field φ(u, n) defined for user u and node n in V. The field φ(u, n) aggregates user-specific signals (e.g., familiarity, mastery, goal similarity, recency, prerequisite status, and time constraints) into a single scalar value that reflects, for example, urgency, expected mastery gain, or curriculum potential at node n. A higher value of φ(u, n) indicates that n is a more suitable next step for user u.

A curriculum trajectory for user u is a walk (n₀, n₁, . . . , n_T) over the graph such that successive nodes approximate following the graph-gradient of the curriculum field, e.g., φ(u, nₜ₊₁)≥φ(u, nₜ) subject to constraints such as prerequisite satisfaction and time budget. In some embodiments, discrete region labels (forward, skipped, lateral) are not computed, and recommendations are generated solely from the curriculum field φ(u, ⋅) and local graph neighborhoods.

Shown throughout the figures, the present disclosure is directed to computer-implemented systems and methods that maintain a semantic progression layer over graph-structured data, with a focus on identifying efficient paths of progression relative to a user's goals. In some embodiments, this semantic progression layer underlies one or more recommender systems that consume its outputs.

The various embodiments throughout the disclosure will be explained in more detail with reference to FIGS. 1-5.

FIG. 1 shows an exemplary networked environment 100, in accordance with some embodiments of the present disclosure.

With reference to FIG. 1, the networked environment 100 may include a system 106, a plurality of user devices (102-1 . . . 102-N) associated with a plurality of users (not shown), and a plurality of data sources (108-1 . . . 108-N). It may be appreciated that the user devices (102-1 . . . 102-N) may be individually referred to as the user device 102 and collectively referred to as the user devices 102, and the data sources (108-1 . . . 108-N) may be individually referred to as the data source 108 and collectively referred to as the data sources 108. A person of ordinary skill in the art will understand that there may be any number of user devices 102 and/or data sources 108 within the scope of the present disclosure.

In some embodiments, each user device 102 comprises a digital platform (110-1 . . . 110-N) communicatively coupled with the system 106. In some embodiments, the digital platform (110-1 . . . 110-N) may be a mobile application (“app”). The mobile application may be installed on the user device 102. In some embodiments, the digital platform (110-1 . . . 110-N) may be a web application (e.g., a website or a webpage). In some embodiments, the digital platform (110-1 . . . 110-N) may be a desktop application. The digital platform (110-1 . . . 110-N) in conjunction with a processing unit (112-1 . . . 112-N) may render a graphical user interface on the user device 102 such that a user of the user device 102 may communicate with the system 106 via the graphical user interface rendered on the user device 102. The graphical user interface may be rendered on the user device 102 under control of the system 106. In some embodiments, the digital platform (110-1 . . . 110-N) may be hosted on the system 106.

Referring to FIG. 1, the system 106 may be communicatively coupled to the plurality of user devices 102 via a communication network 104. In some embodiments, the system 106 may include suitable logic, circuitry, interfaces, and/or code to receive user inputs or requests from each of the plurality of user devices 102 associated with the plurality of users. By way of example and not limitation, such user inputs may include professional information (e.g., employment history, skill assessments, or career goals), academic data (e.g., courses taken, degrees pursued, or learning objectives), personal project details (e.g., open-source contributions, coding platforms, or creative portfolios), and overall content-consumption history (e.g., videos watched, articles read, or online courses accessed on various platforms). In certain embodiments, the user input may also capture broader contextual information—such as time constraints or specific learning milestones—to facilitate more tailored recommendations. A person of ordinary skill in the art will appreciate that additional categories or variants of user input may be incorporated without departing from the scope of the present disclosure, and any sensitive data may be anonymized or handled according to applicable privacy regulations.

Referring to FIG. 1, examples of the system 106 may include, but are not limited to, a computer workstation, a mainframe computer, a handheld computer, a cellular/mobile phone, and other computing devices. In some embodiments, the system 106 may be implemented as a cloud server which may execute operations through web applications, cloud applications, Hypertext Transfer Protocol (HTTP) requests, repository operations, file transfer, and the like. Other examples of the system 106 may include, but are not limited to, a database server, a file server, a web server, a media server, an application server, a mainframe server, a cloud server, or other types of servers. In some embodiments, the system 106 may be implemented as a plurality of distributed cloud-based resources by use of several technologies that are well known to those skilled in the art.

In some embodiments, each of the plurality of user devices 102 may include suitable logic, circuitry, interfaces, and/or code that may be configured to receive the user input from the corresponding user. Specifically, each of the plurality of user devices 102 may be configured to receive the user input from the corresponding user and transmit the received user input to the system 106.

Examples of each of the plurality of user devices 102 may include, but are not limited to, a telephone, a smartphone, a cellular phone, a mobile phone, a personal digital assistant (PDA) device, a tablet, a gaming device, a computing device, an imaging device, a mainframe machine, a server, a computer work-station, and the like. In some embodiments, the plurality of user devices 102 may include, but is not limited to, any electrical, electronic, electro-mechanical, or an equipment, or a combination of one or more of the above devices such as virtual reality (VR) devices, augmented reality (AR) devices, a general-purpose computer, desktop, personal digital assistant, mainframe computer, or any other computing device, wherein the plurality of user devices 102 may include one or more in-built or externally coupled accessories including, but not limited to, a visual aid device such as camera, audio aid, a microphone, a keyboard, and input devices for receiving input from the corresponding user such as touch pad, touch enabled screen, electronic pen, and the like.

A person of ordinary skill in the art will appreciate that the plurality of user devices 102 may not be restricted to the mentioned devices and various other devices may be used.

In some embodiments, each user device of the plurality of user devices 102 may include a display device. The display device may include suitable logic, circuitry, and interfaces that may be configured to display the user input(s), confirmation message, user information, or the like. The display device may be further configured to display a set of user interface (UI) elements to receive the user input and/or request. The display device may be a touch screen which may enable the corresponding user to provide the user input via the display device. The touch screen may include, but not be limited to, a resistive touch screen, a capacitive touch screen, or a thermal touch screen. The display device may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with some embodiments, the display device may refer to a display screen of a head mounted device (HMD), a smart-glass device, a see-through display, a projection-based display, an electro-chromic display, or a transparent display.

Referring to FIG. 1, the communication network 104 may include a communication medium through which the system 106 and the plurality of user devices 102 may communicate with each other. The communication network 104 may be a wired or wireless communication network. Examples of the communication network 104 may include, but are not limited to, the internet, a cloud network, a Wireless Fidelity (Wi-Fi) network, a Personal Area Network (PAN), a Local Area Network (LAN), or a Metropolitan Area Network (MAN). Various devices in the networked environment 100 may be configured to connect to the communication network 104, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), HTTP, File Transfer Protocol (FTP), wireless access point (AP), device to device communication, cellular communication protocols, and Bluetooth (BT) communication protocols, or the like.

The networked environment 100 may also include a plurality of data sources 108 that may provide data to the system 106. In an example embodiment, the data sources 108 may include, but are not limited to, banks and financial institutions, schools and educational institutions, government entities, social media platforms, facial recognition devices, health and fitness trackers, e-commerce platforms, email and communication tools, and the like.

In operation, the system 106 may be configured to expose outputs derived from three regions in a knowledge graph relative to the history of data gathered from the user. In some embodiments, these outputs may include recommendations; in others, they may include visualizations, guided navigation, or other progression-oriented signals. By integrating data from multiple sources 108, the system 106 processes the data to provide personalized progression insights and recommendations, helping users achieve their goals.

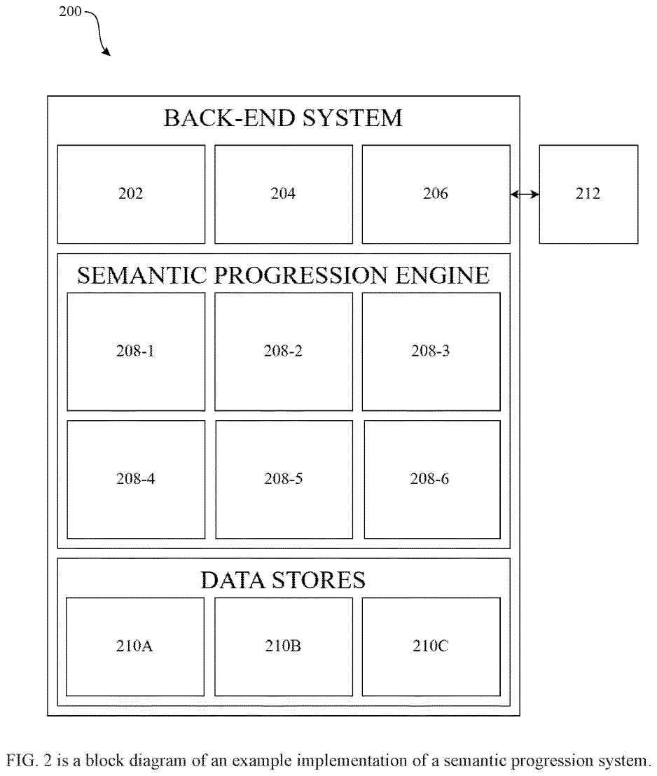

In some embodiments, a request (e.g., to optimize content consumption by the user) may be received from the user device (e.g., 102-1) via the digital platform 110-1 by the system 106. In response thereto, data from the plurality of data sources 108 may be collected by the system 106. The diverse data set provides a comprehensive view of the user's history. The system 106 may integrate the collected data into a centralized database (e.g., 210 of FIG. 2), ensuring that all relevant information is available for processing and analysis.

A base graph populated by internet-sourced content may be initialized by the system 106. This graph may be organized into an ontology that defines topics and sub-topics, potentially spanning multiple difficulty levels or prerequisite structures. For each user, a set of paths is drawn onto this base graph, starting from one or more “entry-level” content nodes, sub-topics, or topics that are low in a given dimension of interest (e.g., difficulty, prerequisite status). Even if a user's familiarity is scattered, sparse (i.e., covering isolated areas of the base graph), or non-existent, the system can still determine how to draw paths from root or prerequisite nodes. In some embodiments, three categories of regions—“forward,” “skipped,” and “lateral”—are identified relative to these user-specific paths, enabling the system 106 to function as a semantic progression layer. Downstream components can use this layer to generate nuanced recommendations or other guidance. Consequently, this layered modeling approach provides the user with a more structured progression toward their learning or exploration goals.

In some embodiments, incoming data is added to the graph data structure in order to enrich both the base graph and any user-specific overlays. The data may include user preferences, goals, or schedules, as well as metadata derived from media content (e.g., via video and image transcription to extract relevant keywords). These keywords can be mapped to specific topics or sub-topics within the ontology. In certain implementations, an AI-driven or manually curated ontology may distinguish basic, intermediate, and advanced concepts as separate sub-graphs. Supervised learning techniques may further assist in classifying or tagging incoming content. Different sub-graphs or ontologies can coexist, reflecting various domains or knowledge hierarchies within the same overall structure.

In some embodiments, the ingested data can be categorized into two broad groups. The first group comprises data gathered from general internet sources—through web crawls or external APIs—that helps populate or expand the base graph. The second group comprises user-specific data, gathered from the user's own devices or connected platforms, which is processed before being mapped onto the base graph. This user-specific data forms a “superposed graph” that captures the user's current familiarity, interests, or progress relative to the base graph.

Once the user's superposed graph has been established (or updated), the system 106 may generate personalized progression signals—such as recommendations or other progression-related outputs—aimed at optimizing the user's content consumption. For example, the system may highlight advanced content (“forward”) to deepen expertise, identify important foundational topics (“skipped”) that the user may have missed, and suggest tangential areas (“lateral”) for broadening the user's overall knowledge. By providing a clear roadmap of relevant topics, the system reduces knowledge gaps and helps guide the user toward a more structured learning or exploration experience.

Although FIG. 1 shows exemplary components of the networked environment 100, in other embodiments, the networked environment 100 may include fewer components, different components, differently arranged components, or additional functional components than depicted in FIG. 1. Additionally, or alternatively, one or more components of the networked environment 100 may perform functions described as being performed by one or more other components of the networked environment 100.

FIG. 2 shows a block-diagram representation 200 of an exemplary system 106, in accordance with some embodiments of the present disclosure.

Referring to FIG. 2, the system 106 may include one or more processors 202, memory 204, interface(s) 206, a semantic progression engine 208, and data stores 210A-210C. In some embodiments, the processor(s) 202 comprise suitable logic, circuitry, and interfaces configured to execute instructions for various operations performed by the system 106. By way of example and not limitation, such operations may include receiving user inputs, collecting and normalizing event signals, initializing and updating a base knowledge graph, superposing user-specific familiarity information onto that graph, computing region membership, and providing progression-related constructs and/or generating recommendations. The processor(s) 202 may also execute applications that expose network APIs to client devices (212) via interface(s) 206.

Data stores and external clients. The data stores include a graph store 210A holding nodes and typed edges (including prerequisite edges), a region-bitset store 210B holding disjoint bitsets (FWD/SKIP/LAT) and related metadata, and auxiliary store(s) 210C for logs, telemetry, audits, and feature flags. Interface(s) 206 provide network and I/O connectivity between the back-end system and client devices 212.

In some embodiments, the one or more processor(s) 202 may be implemented as one or more microprocessors, microcontrollers, DSPs, CPUs/GPUs/TPUs/ASICs, or other logic devices. Among other capabilities, the one or more processor(s) 202 may be configured to fetch and execute computer-readable instructions stored in the memory 204 of the system 106. The memory 204 may be configured to store one or more computer-readable instructions or routines in a non-transitory computer readable storage medium, which may be fetched and executed to create or share data packets over a network service. The memory 204 may store program code and working sets in non-transitory media, including, for example, volatile memory such as Random-Access Memory (RAM), or non-volatile memory such as Electrically Erasable Programmable Read-only Memory (EPROM), flash memory, and the like.

In some embodiments, the system 106 may include the interface(s) 206. The interface(s) 206 may comprise a variety of interfaces, for example, interfaces for data input and output devices, referred to as input/output (I/O) devices, storage devices, and the like. The interface(s) 206 may comprise I/O, storage, and network interfaces and may facilitate communication between system components and the plurality of client devices 212 over the communication network 104. The interface(s) 206 may also provide a communication pathway for one or more components of the system 106. Examples of such components include, but are not limited to, the processing engine(s) 208 and the data stores 210A-210C (graph store, region bitset store, auxiliary). In some embodiments, the database 210 may comprise data that may be either stored or generated as a result of functionalities implemented by any of the components of the system 106. The database 210 may store the user input. In some embodiments, the database 210 may store profiles associated with each of the plurality of users. In some embodiments, the database 210 may store the data collected from the data sources 108.

In some embodiments, the interface(s) 206 may include suitable logic, circuitry, and interfaces that may be configured to facilitate a communication between the processor(s) 202 and the plurality of user devices 102 via the communication network 104. The interface(s) 206 may be implemented by use of various known technologies to support wired or wireless communication of the system 106 with the communication network 104. The interface 206 may include an antenna, a radio frequency (RF) transceiver, one or more amplifiers, a tuner, one or more oscillators, a digital signal processor, a coder-decoder (CODEC) chipset, a subscriber identity module (SIM) card, a local buffer circuitry, and the like.

In an embodiment, the semantic progression engine 208 is implemented as software and/or circuitry that performs the functions described below. In examples, described herein, such combinations of hardware and programming may be implemented in several different ways. For example, the programming for the processing engine(s) 208 may be processor-executable instructions stored on a non-transitory machine-readable storage medium and the hardware for the one or more processor(s) 202 may comprise a processing resource (for example, one or more processors), to execute such instructions. In the present examples, the machine-readable storage medium may store instructions that, when executed by the processing resource, implement the processing engine(s) 208. In such examples, the user device 102 may comprise the machine-readable storage medium storing the instructions and the processing resource to execute the instructions, or the machine-readable storage medium may be separate but accessible to the user device 102 and the processing resource. In other examples, the processing engine(s) 208 may be implemented by an electronic circuitry.

In an exemplary embodiment, the semantic progression engine 208 comprises the following modules:
208-1 Familiarity Calculator. Computes familiarity scores F(u, n)per Eq. (1) from consumption, verification, and dwell-time signals with recency decay, and updates the familiar set Sᵤ.
208-2 Goal Mapping. Maps user-provided or inferred goals to one or more goal nodes in the knowledge graph.
208-3 Delta Update Engine. Upon a familiarity threshold crossing (t) or a change in shortest-path parentage, writes region-bitset deltas to 210B and updates affected records.
208-4 Backbone Constructor. Selects shortest paths along prerequisite edges from familiar nodes to one or more roots and stores the union as the user backbone.
208-5 Region Detector. Detects SKIPPED, FORWARD, and LATERAL membership per the definitions herein (e.g., Def. D4) and enforces pairwise disjointness.
208-6 Progression Construct Assembler/Output Interface. Ranks candidates per Eq. (2) (e.g., goal similarity, coverage gain, familiarity, redundancy) and produces region-specific candidate sets, ranked candidate sets, and/or progression-related constructs for downstream components.

In certain implementations, machine-learning components (e.g., classifiers for prerequisite inference or goal mapping) and data-ingestion pipelines operate behind interface(s) 206 and persist their outputs to 210A-210C; these supporting components are not required to be shown in FIG. 2.

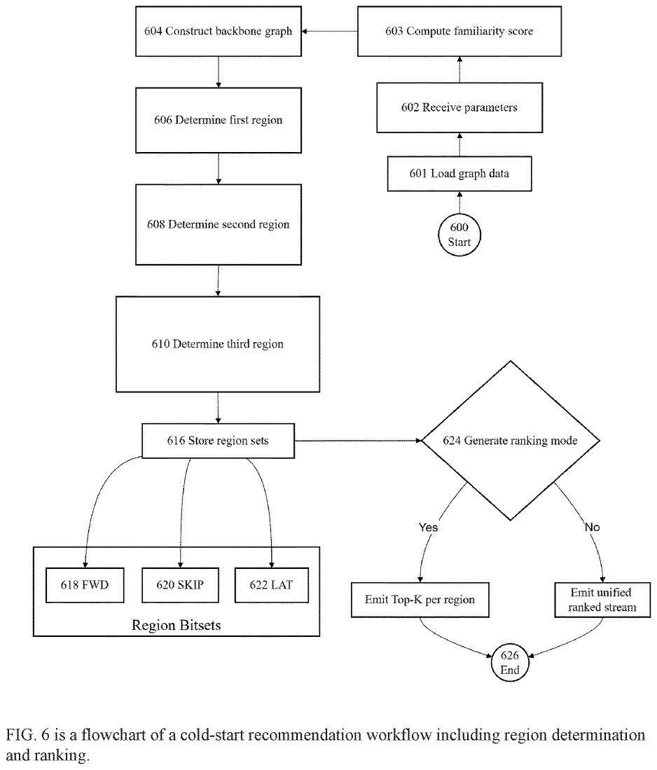

With reference to FIG. 6, the cold-start workflow initializes progression regions for a semantic progression layer from a consistent snapshot of (i) the user's familiar set S_u, (ii) the chosen dimension of interest d, and (iii) the prerequisite subgraph. The system computes SKIP, FWD, and LAT per Def. D4 and enforces pairwise disjointness per [0049]/Inv. 11. One or more progression-related constructs are derived from the computed regions, including, for example, region bitsets, candidate-node sets identified by set bits, and/or a ranked list of candidate nodes scored per Eq. (2), and are provided to one or more downstream components for generation of progression-related outputs, including recommendations, structured guidance, navigation cues, visualizations, or schedules.

In one embodiment, discovery of region supersets proceeds in parallel and reconciliation is performed by bitwise subtraction over region bitsets as described in [0048], preserving SKIP→FWD→LAT precedence while enabling parallel execution and incremental bitset-delta writes for maintaining progression-region membership at scale.

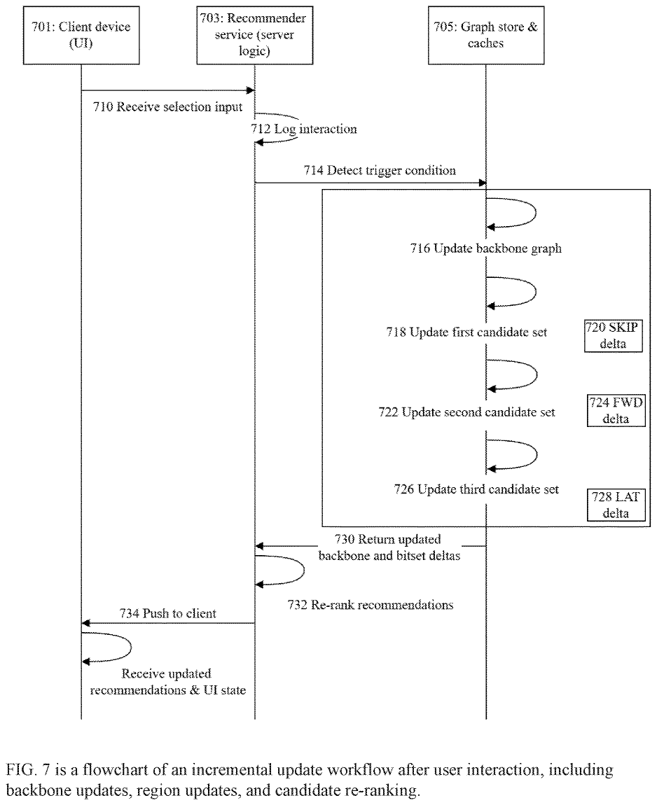

With reference to FIG. 7, after a user event—such as acceptance of a recommendation, completion of an assessment, or another interaction signal—the system applies an incremental recomputation. Nodes whose familiarity F(u,n) crossed the threshold t or whose shortest-path parents changed are identified; the backbone union of shortest prerequisite paths is updated; and region bitsets (FWD/SKIP/LAT) receive delta writes localized to the affected neighborhoods, followed by updating one or more derived progression-related constructs, including updating impacted candidate sets and/or re-ranking impacted candidates per Eq. (2). This limits traversal cost and reduces recomputation latency compared to full recomputation (see [0009] and [0128]).

In certain implementations, a user event triggers updates to coverage_gain(⋅) with respect to the updated backbone, enabling immediate promotion of newly reachable forward candidates while maintaining region disjointness, and enabling downstream components to refresh one or more progression-related outputs based on the updated progression-related constructs.

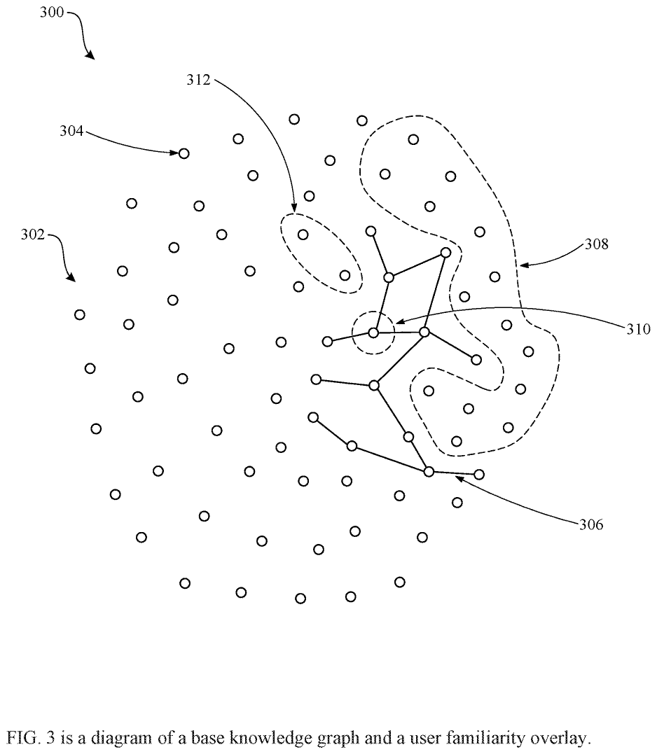

FIG. 3 shows a representation 300 of the base graph data structure with a superposed graph data structure representing a single user by the example system 106, in accordance with embodiments of the present disclosure.

Referring to FIG. 3, the representation 300 shows a graph 302 where edges between nodes are not shown. Each node 304 in the graph 302 represents a topic, sub-topic, or content on the internet that has been organized into a graph. The superposed per-user graph 306 (where edges between nodes are shown) represents topics, sub-topics, or content that the user is familiar with. Three areas become of interest for driving progression-related outputs. In one embodiment these outputs include recommendations, but other embodiments may employ the same regions to power visualizations, study plans, or interactive guidance. The first area 308 represents content that is more advanced and brings the user closer to their goals provided as input. The second area 310 represents content that the user should be familiar with but may have skipped according to their history and the progression of content defined in the graph. The third area 312 represents content that expands the user's breadth of content consumption. It should be noted that FIG. 3 depicts only one such sub-graph for illustrative purposes; in an actual implementation, the base graph may comprise many sub-graphs or interconnected regions representing various domains, levels, or subject areas. Region indices correspond as follows: 308—forward region, 310—skipped region, and 312—lateral region.

By way of illustration, consider a user “ABC” who wishes to learn a new subject or skill but is unsure how to proceed. The user may not know which subtopics to explore first, how to filter content by difficulty, or even which queries to pose to a large language model. Seeking guidance, the user semantic progression system 106 via the digital platform 110-1. The user can input personal goals, learning preferences, or other parameters. Meanwhile, the system 106 may collect supplemental data from the user's connected sources (e.g., 108), such as relevant content platforms or online repositories. By aggregating these inputs, the system constructs a comprehensive profile of the user's existing familiarity across one or more subject domains-regardless of whether the user specifically filters by topic. This approach provides a more targeted roadmap for content consumption, ensuring that ABC receives recommendations aligned with both immediate knowledge gaps and longer-term objectives.

Despite the widespread adoption of knowledge graphs and machine-learning techniques in graph-driven systems, existing solutions often emphasize local similarity, proximity, or user-to-user correlation signals (e.g., collaborative filtering) to surface items. Such systems rarely provide a structured semantic progression layer that models a user's evolving familiarity or mastery across a multi-level graph and that exposes progression-oriented constructs—such as gaps, prerequisites, and forward reachability—usable to generate roadmaps, guided navigation, or other adaptive outputs. Consequently, many conventional systems fail to provide a cohesive path from foundational to advanced concepts, and instead operate as flat item-surfacing mechanisms that do not explicitly represent where the user is positioned within an overall semantic structure.

By contrast, the present disclosure provides a graph-based approach that overlays each user's familiarity state onto a base knowledge graph to form a per-user semantic progression layer. This layering enables the system to dynamically identify progression-related regions relative to one or more dimensions of interest, including: (1) a forward region representing nodes beyond the user's current familiarity along the dimension of interest, (2) a skipped region representing prerequisite or preceding nodes not detected as familiar, and (3) a lateral region representing adjacent nodes that expand breadth while remaining within a tolerance relative to the dimension of interest. These progression-related structures can be consumed by downstream components to generate progression-related outputs, such as ranked candidate-node sets, structured guidance, navigation cues, visual overlays, or recommendations.

Moreover, unlike approaches that rely predominantly on user similarity signals or content-based keyword matching, the disclosed system can incorporate heterogeneous user-specific signals—such as professional data, educational records, social-platform interactions, and other contextual signals—to model how topics, skills, or content nodes interrelate for a particular user. This integrated user-state modelling, combined with the dimension-of-interest concept (e.g., prerequisite structure, difficulty level, curriculum level, or time sequence), enables progression-related constructs and outputs that adapt over time as the user's familiarity, context, and objectives evolve, rather than merely surfacing items that are superficially aligned with prior behavior.

The synergy between the base knowledge graph, the user's superposed familiarity overlay, and the threefold categorization of forward, skipped, and lateral regions is thus distinct from systems that only compute similarity or correlation rankings. This architecture reduces directionless surfacing by explicitly representing what prerequisite material may be incomplete, what forward candidates are reachable for advancement, and what adjacent areas can broaden understanding. In doing so, the present disclosure provides a comprehensive, goal-oriented semantic progression layer that supports multiple downstream progression-related outputs—including, but not limited to, recommendations—while maintaining explainability regarding why particular nodes are surfaced relative to the user's position in the graph.

In some embodiments, the system identifies “skipped” areas in the superposed graph by comparing the user's visited nodes against at least one preceding node in the dimension being traversed. More specifically, if a parent or prerequisite node in that dimension was not detected among the user's visited or consumed content, the system marks that parent or prerequisite node as “skipped.” By way of non-limiting example, each node in the base knowledge graph may contain metadata indicating its direct predecessors or lower-level concepts in the relevant dimension. When the system detects that a user has visited an upper-level node but has no record of visiting one or more corresponding preceding nodes, those nodes are programmatically labeled as “skipped.” This helps guide the user to revisit foundational material and rectify knowledge gaps that might otherwise hamper progress through more advanced topics.

Furthermore, in some embodiments, the system determines which areas of the knowledge graph map to the user's stated or inferred goals, thereby identifying which nodes should be considered high-priority for the user's upcoming recommendations. The mechanism for translating the user's goals to specific nodes or sets of nodes in the knowledge graph may rely on factors such as topic relevance, user context, or additional metadata, but the internal details of that mapping process need not be disclosed herein. Once one or more nodes are flagged as aligning with the user's goals, the system can highlight forward-looking recommendations (i.e., higher-level on the dimension of interest) aimed at reaching those goal-related nodes and may further adapt the recommendation engine over time as the user's goals or context change.

Furthermore, in some embodiments, user goals may span multiple areas of the knowledge graph, in which case the system can map the user's stated objectives to a set of sub-graphs, nodes, or distinct regions. When a user's goals involve a broad domain or multiple interconnected topics, grouping these goals into one or more sub-graphs/regions can facilitate a cohesive set of recommendations across related nodes.

It may be appreciated that the exemplary representation 300 may be modular and flexible to accommodate any kind of changes within the scope of the present disclosure.

Worked example—web framework learning. Let the DoI be prerequisite depth. Nodes include: JavaScript Fundamentals (0), ES6 Syntax (1), React Basics (2), React Hooks (3), React Router (3), TypeScript Basics (2), Redux State Management (4), Next.js Routing (4). Suppose F(u, n)≥τ for React Basics and React Hooks only. The system traces prerequisites to ES6 Syntax and JavaScript Fundamentals.

Detected regions. Using the procedures described herein:
Skipped: JavaScript Fundamentals; ES6 Syntax (each precedes a familiar node and is not familiar).
Forward: Redux State Management; Next.js Routing (strictly higher DoI reachable from familiar nodes).
Lateral: React Router; TypeScript Basics (within k hops of familiar nodes and with |d(n)−d(s)|≥δ).

Top-ranked recommendations are {Redux, Next.js, React Router} for the goal “production-ready React apps.”

Scope of FIG. 3. FIG. 3 illustrates only one example sub-graph for clarity. In practice, the base knowledge graph may comprise numerous sub-graphs and cross-links; the depicted sub-graph is representative rather than exhaustive.

Expert-level illustration. By way of illustration, if a user has ten years of experience as a React developer, the forward region naturally emphasizes advanced, newly emerging materials rather than introductory topics. The system therefore surfaces forward candidates at higher levels of the chosen DoI (e.g., advanced patterns, performance tuning, novel libraries), while de-emphasizing foundational items already familiar to such a user.

Two-subset packaging. In some embodiments, each recommendation set (forward, skipped, lateral) is packaged into two subsets: (i) a material subset comprising consumables (e.g., videos, articles, documentation, code repositories); and (ii) a testing subset linking to external assessment resources (e.g., problem banks or coding judges). For MOOC-style courses (e.g., Coursera-type offerings), the testing subset may be self-contained within the course environment.

Single-list presentation with internal labels. In other embodiments, the forward/skipped/lateral labels are used purely internally. Externally, the system may present a single unified progression stream (for example, a ranked list of candidate nodes or content items), optionally with a user control to filter or toggle among views. Region membership remains an internal label used for scoring, tie-breaking, and auditability.

Topic-level and prompt-level recommendations. Recommendations may target topics (nodes) as well as specific content items. In some embodiments, recommendations are generated as LLM prompts that guide the user to explore a topic, test mastery, or create artifacts aligned to the node's learning objectives.

Vantage-point recommendations; optional fourth set. In some embodiments, the three sets may be computed relative to the user's current browsing point in the graph (e.g., a node viewed in an extension or UI pane). An optional fourth set comprises recommendations anchored at the current node itself. In some embodiments, a new diagram (e.g., FIG. 6) depicts vantage-point centering and dynamic recomputation of the sets as the user navigates.

Spatial gradient view. In some embodiments, although the sets are computed to be pairwise disjoint at recommendation time, the underlying scoring can be rendered as a spatial gradient over the graph, visualizing increasing relevance or urgency (e.g., heat-map shading) while still outputting discrete sets or a unified ranked list.

Curriculum field mode (continuous potential field). In other embodiments, the semantic progression layer is instantiated as a continuous curriculum field φ(u, n) over the graph instead of discrete forward, skipped, and lateral sets. The field φ(u, n) aggregates signals such as goal similarity, expected mastery gain, recency, prerequisite satisfaction, and workload constraints into a single scalar value per node. At recommendation time, the system samples from nodes with locally maximal φ(u, ⋅) in the user's neighborhood, or follows a discrete approximation to a gradient-ascent trajectory on φ(u, ⋅), subject to prerequisite constraints and optional diversity or specialty filters.

In curriculum-field embodiments, FWD/SKIP/LAT may be omitted or used only as an optional interpretive view derived from φ(u, ⋅). The primary outputs include: (i) heatmap visualizations over the graph that show high-potential regions; (ii) curriculum trajectories that trace increasing sequences of φ(u, n) from current mastery regions toward goal nodes; and (iii) continuous priority scores attached to candidate nodes for use by recommendation, scheduling, or LLM-backed guidance modules.

Specialty decomposition. For domains with multiple specialties, each of the three sets may be decomposed per specialty (e.g., front-end, back-end, data-viz). Conversely, the UI may present a separate pane per specialty, each pane containing its own forward, skipped, and lateral subsets.

Live-update layering; heterogeneous context weighting; proprietary heuristics. In some embodiments, the system employs a layered, live-updating pipeline in which familiarity scores and region membership are recalculated as new user signals arrive. Heterogeneous user-context features (e.g., professional history, schedule constraints, device patterns) may be differentially weighted to modulate ranking. Certain ranking heuristics, weighting schemes, and tie-break rules may be maintained as trade secrets and need not be disclosed to practice the invention.

Curriculum import as goals. Formal school curricula and syllabi may be imported and translated into graph structures; their terminal competencies and milestones become goal nodes against which forward progress is measured.

Meta-graph construction. In some embodiments, the base and/or per-domain graphs are produced by pre-processing multiple source graphs and statistical artifacts, such as co-occurrence graphs, prerequisite-inference graphs, citation/link graphs, and curated curricula. These are reconciled into a unified ontology via graph alignment and de-duplication.

Node verification via quizzes; Elo-style mastery. Nodes may be verified by mini-quizzes that include a latency penalty to discourage automated answering, yielding more reliable skill signals. Quiz outcomes update an Elo-style mastery score per node (and optionally per specialty), which in turn modulates familiarity F(u,n) and ranking.

Mastery-gated mode (hard prerequisite constraints). In some embodiments, the semantic progression layer operates in a pure skill-mastery mode in which prerequisite constraints are enforced as hard graph constraints and the primary state variable per node is a mastery score M(u, n) rather than a familiarity threshold. Mastery scores are updated using a rating update rule as described in [0048](for example, an Elo-style update) based on quiz outcomes, task performance, or other verification events. A gating function g(u, x) determines eligibility of a candidate node x: nodes for which any prerequisite p E prereqs(x) has M(u, p)<θ are temporarily ineligible for forward progression and may instead be surfaced as remedial or review items.

In this mastery-gated mode, recommendations are generated by optimizing a mastery-oriented objective such as expected mastery gain per unit time (see [0049]) under the gating constraints. Outputs may include: (i) mastery dashboards that visualize M(u, n) across topics or specialties; (ii) pacing schedules that assign topic clusters to calendar windows or session slots; and (iii) prerequisite-blocked indicators that explain why certain advanced nodes are not yet available. In some embodiments, the FWD, SKIP, and LAT regions are not computed as named sets; instead, the gating function and mastery-oriented objective fully determine progression.

Track completion and zooming. When a track reaches its terminal node, the system may zoom out to a higher-scope parent (topic cluster or specialty) and propose the next track. A diagram (e.g., FIG. 7) may depict multi-scale navigation and roll-up transitions between levels.

Lateral semantics and adjacency. As used herein, “lateral” may also be termed adjacent. Lateral membership may be determined by: (i) neighborhood within k hops in another dimension (e.g., peer difficulty at different sub-topics); and/or (ii) common-parent proximity, where the lateral distance is a function of the least common ancestor's depth. A new diagram (e.g., FIG. 6 or FIG. 8) may illustrate both notions.

Review mode. A review-mode switch may bias recommendations toward areas of strength (high F(u,n)) for spaced-repetition reinforcement, rather than areas of weakness, with scheduling determined by decay p(At) and past performance.

Guided recursion to earlier nodes. The UI may display indications prompting users to recurse to an earlier node adjacent to the current root or sub-root when gaps are detected, thereby re-anchoring the backbone path for subsequent forward progress.

Pathfinding-based display. In some embodiments, the sets are displayed via pathfinding algorithms, such as k-shortest paths or constrained best-first traversals, to show how a recommendation connects to goals and which prerequisites it satisfies.

LLM-backed assistants. The graph may serve as a backend for LLM-based assistants, providing structured retrieval and constraint-aware guidance (e.g., mapping queries to nodes, teasing apart overloaded keywords, and maintaining topical coherence as context windows grow).

Interaction controls. A side panel may expose controls to order, sort, and filter the graph; adjust k, δ, and DoI; toggle forward/skipped/lateral views; pick specialties; and choose whether to show separate sets or a single unified ranked list.

Stateful movement. In some embodiments, selecting a forward, skipped, or lateral recommendation moves the user's position on the graph, instantly updating the superposed graph G_u and re-estimating region membership and rankings.

Mapping events to familiarity. User events—views, completions, quiz scores, and dwell time—are normalized to [0, 1] and combined as in [0036]. A recency-decay factor down-weights older interactions. In one example, τ=0.6.

Backbone construction when familiarity is sparse. For each familiar node s∈S_u, the system performs a reverse traversal along prerequisite edges to a root, selecting the shortest path by hop count or by minimum total edge weight. The union of such paths forms a backbone that is stored for user u. In one embodiment, path selection is implemented with Dijkstra's algorithm with asymptotic complexity O(|E| log |V|) on the prerequisite subgraph.

Region detection; tunables; disjointness procedure. A region-detection procedure includes:
1. Compute S_u and the backbone as in Def. D1 and D3 (see [0042]) and [0120].
2. Skipped: for any familiar node b, if a preceding node a on DoI d exists and F(u, a)<τ, label a as skipped.
3. Forward: from each s∈S_u, traverse outward along edges with strictly increasing d; add first-layer (or path-bounded) nodes to the forward region, excluding familiar and skipped nodes.
4. Lateral: add nodes within k hops of any s with |d(n)−d(s)|≤δ, excluding S_u and the union of the skipped and forward sets. Parameters k∈N and δ≥0 are tunable (typical values: k∈{1,2}, δ∈[0,2]).

Ranking. In some embodiments, a candidate x receives
R(x)=λ₁·goal_sim(x, G_u)+λ₂·coverage_gain(x)+λ₃·(1−F(u, x))−λ₄·redundancy(x),
where goal_sim measures similarity to one or more goal nodes, coverage_gain is the fraction of x's prerequisite nodes newly satisfied with respect to the backbone, and redundancy penalizes near-duplicates to already-selected candidates. One enabled instantiation uses λ₁=0.5, λ₂=0.3, λ₃=0.2, λ₄=0.1 and coverage_gain(x)=|{p∈prereqs(x): p becomes satisfied if x is added}|/|prereqs(x)|. In some embodiments, Top-K recommendations are output per region; in others, a single unified ranked list is presented. Other embodiments may employ non-linear, learned, or multi-objective ranking functions. Top-K denotes selecting the K highest-scoring candidates for an integer K≥1 (e.g., K=10).

Incremental recomputation; latency. Upon acceptance of a recommendation, the system updates the user's position, adjusts F(u, n) for affected nodes, and incrementally recomputes the backbone and region bitsets by limiting traversal to nodes whose familiarity crossed t or whose shortest-path parents changed. In one embodiment, limiting recomputation to the affected neighborhoods and applying bitset delta writes reduces recomputation latency compared to full recomputation over V.

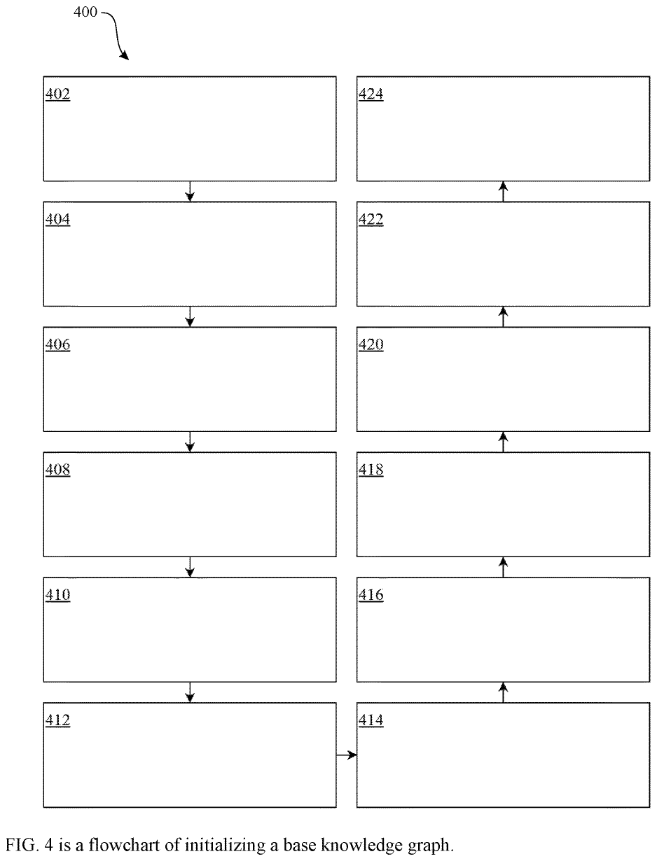

FIG. 4 shows a flow chart of an example method 400 for initializing and producing a versioned base knowledge graph, in accordance with embodiments of the disclosure. FIG. 4 is explained in conjunction with elements from FIG. 1 (e.g., system 106, data sources 108, and data stores 210A-210C). The steps from 402 to 424 may be implemented by any suitable computing system, such as the system 106 of FIG. 1.

Block 402 (Provision data stores). The system 106 provisions graph and auxiliary stores (e.g., 210A-210C), creating tables/collections for nodes, typed edges, attributes, embeddings, clustering artifacts, nearest-neighbor indices, and metrics. One embodiment materializes tables such as nodes, edges_* (including prerequisite and similarity edges), node_attrs, embeddings, edges_knn, and metrics.

Block 404 (Register sources). The system registers raw data sources 108 and any auxiliary corpora with adapters and schedules. Sources may include Q&A forums, documentation sites, educational repositories, code solutions, or API feeds. Each source is assigned ingestion parameters (format, cadence, retention) and provenance tags.

Block 406 (Ingest raw content). The system loads raw artifacts (e.g., posts, pages, comments, tags, votes, reactions, timestamps) and records source metadata (crawl time, content IDs, checksums). Content is stored in staging areas of 210C prior to normalization.

Block 408 (Normalize & canonicalize keywords). The system applies normalization rules to map noisy labels to canonical forms (e.g., lemmatization, case/diacritic folding, synonym resolution). Canonical forms and statistics are written to attribute tables (e.g., tag_canonical, tag_canonical_stats) for subsequent node building.

Block 410 (Build node catalog). The system materializes one node per canonical topic and attaches attributes (popularity, temporal signals, text summaries) in node_attrs. In some embodiments, nodes correspond to topics, sub-topics, or skills; in others, nodes may include content items that are later rolled up to topic nodes.

Base graph construction. Nodes are created from discovered content items; edges include at least prerequisite links authored or inferred by a classifier. The DoI d may be: (a) a curated curriculum level; (b) a topological order over the prerequisite subgraph; or (c) a regression-based difficulty score.

Block 412 (Compute node features). The system generates features used downstream, such as text/usage embeddings, acceptance/answer statistics, popularity time series, trend metrics, and other derived signals. Features are persisted for ranking and edge inference (e.g., in embeddings, tag_metrics).

Block 414 (Derive relationships-typed edges). The system computes multiple edge families: (i) co-occurrence and association (e.g., PMI/CPMI); (ii) embedding-based nearest neighbors; (iii) heuristic/policy-filtered edges; and (iv) optionally, prerequisite/part-of hints derived from features and curated rules. Raw scores and filtered edges are stored in edges_raw, edges_pmi, edges_knn, and edges_filtered within 210A.

Block 416 (Cluster & label regions). Community detection and tiering produce clusters/tiers of related topics. Human-readable labels (or automatically generated labels) are assigned and saved (e.g., cluster_labels) to support navigation and curriculum views.

Block 418 (Validate & prune). The system enforces schema and graph constraints, drops low-confidence edges, and ensures invariants (e.g., no self-loops in prerequisite edges; bounded out-degree). Failed records are quarantined with provenance for auditability.

Block 420 (Persist graph snapshot). The system writes a versioned, immutable snapshot of nodes, features, and typed edges to 210A, together with a build manifest and provenance, enabling reproducible downstream recommendation runs.

Block 422 (Build indexes & caches). The system constructs search/ANN/lookup indexes and traversal caches required for fast query-time operations by the recommender engine 208 (e.g., k-NN indices over embeddings and adjacency caches).

Block 424 (Expose interfaces). Read APIs are exposed via interfaces 206 to allow the recommender engine 208 and client services 212 to query nodes, edges, features, clusters, and snapshots. In some embodiments, the APIs support snapshot selection by version tag.

While FIG. 4 illustrates a Q&A-style corpus as a concrete example, other embodiments may apply the same pipeline to documentation sets, textbooks, MOOCs, research libraries, or mixed corpora. The pipeline is orthogonal to per-user processing (e.g., familiarity computation and region detection), which is described elsewhere herein.

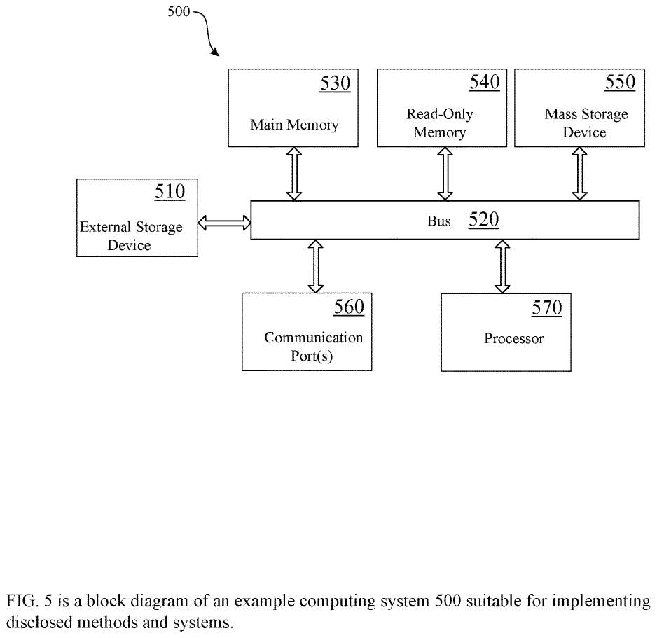

FIG. 5 illustrates an example computer system 500 in which or with which embodiments of the present disclosure may be implemented. In some embodiments, the system 106 of FIG. 1 may be implemented as the computer system 500. Alternatively, or additionally, the plurality of user devices 102 of FIG. 1 may also be implemented as the computer system 500.

As shown in FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication ports. The processor 570 may include various modules associated with embodiments of the present disclosure. The communication port(s) 560 may be chosen depending on a network, such a Local Area Network (LAN), Wide Area Network (WAN), or any network to which the computer system 500 connects. The main memory 530 may be Random-Access Memory (RAM), or any other dynamic storage device commonly known in the art. The read-only memory 540 may be any static storage device(s) e.g., but not limited to, a Programmable Read Only Memory (PROM) chips for storing static information e.g., start-up or BIOS instructions for the processor 570. The mass storage device 550 may be any current or future mass storage solution, which can be used to store information and/or instructions.

The bus 520 communicatively couples the processor 570 with the other memory, storage, and communication blocks. Optionally, operator and administrative interfaces, e.g., a display, keyboard, joystick, and a cursor control device, may also be coupled to the bus 520 to support direct operator interaction with the computer system 500. Other operator and administrative interfaces can be provided through network connections connected through communication port(s) 560. The external storage device 510 may be any kind of external hard-drives, floppy drives, or the like. Components described above are meant only to exemplify various possibilities. In no way should the aforementioned exemplary computer system 500 limit the scope of the present disclosure.

The methods described herein may be performed using the systems described herein. In addition, it is contemplated that the methods described herein may be performed using systems different than the systems described herein. Moreover, the systems described herein may perform the methods described herein and may perform or execute instructions stored in a non-transitory computer-readable storage medium (CRSM). The CRSM may comprise any electronic, magnetic, optical, or other physical storage device that stores executable instructions. The instructions may comprise instructions to cause a processor to perform or control performance of operations of the proposed methods. It is also contemplated that the systems described herein may perform functions or execute instructions other than those described in relation to the methods and CRSMs described herein.

Furthermore, the CRSMs described herein may store instructions corresponding to the methods described herein, and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

In some embodiments the method or methods described above may be executed or carried out by a computing system (for example, the computer system 500 of FIG. 5) including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

Multi-dimensional progression; Pareto frontiers. In some embodiments, the system defines multiple ordered dimensions of interest per node rather than a single scalar. For instance, a first dimension may encode prerequisite depth, a second dimension may encode estimated time cost, and a third dimension may encode relevance to one or more goal nodes. For a given user and request context, the system constructs a candidate set of nodes from one or more region bitsets, eligibility bitsets, or curriculum-field neighborhoods. The candidate set is represented as a candidate bitset CAND[u] over V. Dimension-specific score arrays are consulted to evaluate dominance relationships among candidates. Nodes that are dominated across all dimensions by some other candidate are cleared from CAND[u] using bitwise AND-NOT operations. After convergence, the remaining set bits in CAND[u] are copied into a frontier bitset FRONT[u] that compactly represents a Pareto-efficient frontier for that user and context. Recommendation modules may then select nodes exclusively from FRONT[u], optionally applying secondary ranking criteria within the frontier.

### Equation (7)—Frontier-Constrained Candidate Set.

In embodiments that combine frontier computation with gating constraints, a final selection candidate set for user u is derived from the intersection of a frontier bitset FRONT[u] and an eligibility bitset ELIG[u]. Let 1_{FRONT[u]}(n) and 1_{ELIG[u]}(n) denote the respective bit indicators. A node n is considered selectable if:

$$sel ( u , n ) = 1 \_ \{ FRONT [ u ] \} ( n ) \cdot 1 \_ \{ ELIG \{ u ] \} ( n ) = 1 .$$

In one implementation, only nodes with sel(u, n)=1 are scored by a bandit-style selection score S(u, n) as in Equation (5); nodes with sel(u, n)=0 are ignored until their frontier or eligibility status changes.

Frontier-aware ranking and visualization. In some embodiments, nodes on the frontier bitset FRONT[u] are further divided into bands based on scalar projections of their multi-dimensional scores (for example, via a weighted sum of dimensions or a learned scoring model). The bands may be used to structure recommendation carousels or to color-code nodes in a visualization. The frontier bitset itself can be served to a client user interface, enabling the client to highlight non-dominated nodes while de-emphasizing dominated alternatives. Because FRONT[u] is represented as a bitset, updates to the frontier in response to changes in the candidate set or in underlying dimension scores can be implemented via localized bit operations without scanning all nodes in the knowledge graph.

Diagnostic/information-gain mode. In some embodiments, the semantic progression layer operates in a diagnostic mode in which the primary objective is to reduce uncertainty about the user's state rather than to directly advance along a curriculum. In diagnostic mode, the system consults the diagnostic candidate bitset DIAG[u] and, for each node whose bit is set, computes an expected information gain value IG(u, n) based on the user's current mastery and uncertainty estimates and a model of possible assessment outcomes at that node. The expected information gain may be estimated by simulating or analytically integrating over discrete score outcomes and measuring the resulting reduction in a global uncertainty metric, such as the sum of entropies or variances across nodes of interest. The system selects one or more nodes with maximal IG(u, n) or with IG(u, n) above a specified percentile to present as diagnostic interactions to the user. Responses to these interactions update mastery and uncertainty estimates for the assessed nodes and for related prerequisite or successor nodes, thereby shrinking the space of plausible user states. Upon completion of a diagnostic burst, the system may switch back to a progression-oriented mode using updated mastery and familiarity signals.

Graph-constrained bandit and reinforcement-learning policies. In other embodiments, recommendation selection is driven by a contextual bandit or reinforcement-learning policy rather than a fixed ranking function. Each node or group of nodes is modelled as an arm with an associated reward estimate \hat{R}(u, n). The eligibility bitset ELIG[u] is used to encode graph-constrained gating conditions so that arms corresponding to nodes with unset eligibility bits are not considered at selection time. For each node whose bit in ELIG[u] is set, a selection score S(u, n) is computed as a function of the reward estimate and an exploration bonus, such as an upper-confidence-bound, Thompson sampling score, or another exploration heuristic. The system selects a node with a maximal selection score among eligible nodes and surfaces it as a recommendation. After the user interacts with the recommended node, the system records a realized reward signal (e.g., mastery gain, dwell time, explicit rating) and updates the reward estimate and, where applicable, the parameters of the bandit or reinforcement-learning policy. In this manner, the system learns over time which regions of the graph produce better outcomes for the user while continuing to respect prerequisite and gating constraints encoded in ELIG[u].

Cohort-level overlays and assignments. In some embodiments, the semantic progression layer is instantiated at the level of a cohort of users, such as a classroom, organization unit, or study group. For each user in the cohort, user-specific region bitsets FWD[u], SKIP[u], and LAT[u] are maintained as described above. Cohort-level region bitsets, such as FWD_union[C] and SKIP_union[C], are computed by applying bitwise OR across the corresponding per-user bitsets for all u E C, while FWD_intersect[C] and SKIP_intersect[C] are computed by applying bitwise AND across per-user bitsets. A cohort-level objective may prioritize, for example, reducing the size of SKIP_union[C] for a required curriculum, or maximizing the number of users whose familiar set covers nodes on FWD_union[C] before a deadline. Cohort-level assignments are generated by selecting node identifiers whose bits are set in one or more cohort-level region bitsets and whose inclusion improves the cohort-level objective, and by distributing those nodes to one or more cohort members as recommendations, tasks, or lessons.

Cohort progression dashboards and interventions. In some embodiments, a cohort-level dashboard visualizes the status of cohort-level bitsets over time, such as the fraction of cohort members who have cleared particular skipped nodes, or the distribution of mastery scores across nodes in FWD_union[C]. The system may suggest interventions to an instructor or administrator, such as adding a remedial session for nodes with high SKIP_union[C] density or splitting the cohort into sub-cohorts with different progression tracks based on their backbone coverage or frontier membership. Because cohort-level bitsets are derived from per-user bitsets via word-level bitwise operations, these visualizations and interventions can be updated incrementally as user-level events arrive.

Integration with curriculum-field and region-based embodiments. The multi-dimensional frontier, diagnostic, bandit, and cohort-level embodiments described herein are not limited to any single representation of progression. In some implementations, the frontier bitset FRONT[u]is computed over candidates drawn from the forward, skipped, and lateral regions. In other implementations, candidates are drawn from nodes whose curriculum-field values φ(u, n) exceed a threshold or from nodes reachable within a hop limit from a current vantage node. Similarly, the diagnostic candidate bitset DIAG[u] and eligibility bitset ELIG[u] may be populated from region membership, curriculum-field thresholds, mastery-gating criteria, or combinations thereof. Thus, the described mechanisms may be layered atop the FWD/SKIP/LAT region model, the mastery-gated model, or the curriculum-field model.

Implementation considerations. The bitsets and arrays described herein—including but not limited to region bitsets FWD/SKIP/LAT, the frontier bitset FRONT, the candidate bitset CAND, the diagnostic candidate bitset DIAG, the eligibility bitset ELIG, and cohort-level union and intersection bitsets—may be implemented as contiguous arrays of machine words, compressed bitmaps, or sharded bitset structures. Bitwise AND, OR, and AND-NOT operations are applied over blocks of machine words to implement set intersection, union, and subtraction. In one embodiment, dimension-specific score arrays, reward estimates, uncertainty estimates, and mastery scores are stored in columnar structures keyed by node identifier, enabling cache-friendly iteration aligned with bitset blocks. The specific storage layout and numerical representations are not limiting, and alternative implementations that maintain the functional relationships described herein are within the scope of the present disclosure.

Region-bitset store keyed by stable node identifiers. In some embodiments, each node in the base knowledge graph is assigned a stable node identifier (e.g., an integer ID) that remains invariant across updates to node attributes and across successive versioned snapshots of the base knowledge graph. The region-bitset store maintains, for each user, at least three region bitsets—FWD[u], SKIP[u], and LAT[u]—where each bit position corresponds to a respective stable node identifier. A region-bitset record may be addressed by a composite key comprising (user identifier, region identifier, and optionally a graph-snapshot identifier or epoch identifier). In some implementations, the region-bitset store is a key-value store, a memory-mapped file, a columnar store, or a distributed storage service; the particular storage mechanism is not limiting so long as it supports reading and updating bit positions for stable node identifiers.

Word-addressable mapping from node identifier to bit position. In one embodiment, each region bitset is stored as a contiguous array of fixed-width machine words. For an N-bit bitset represented by W-bit machine words (e.g., W=64), the bit position corresponding to node identifier i is located at word index └i/W┘ and bit offset (i mod W). Region membership queries are serviced by reading the corresponding machine word and testing the bit mask for the bit offset. This layout improves cache locality and supports block-wise bitwise set operations (e.g., AND, OR, AND-NOT) over contiguous machine-word ranges.

Persisted disjointness invariant and reconciliation procedure. In some embodiments, the system enforces and persists a disjointness invariant across the three region bitsets for each user: no node identifier is represented in more than one of FWD[u], SKIP[u], and LAT[u]. Disjointness is enforced by an exclusion precedence in which SKIP has priority over FWD, and the union of SKIP and FWD has priority over LAT. In a word-based bitset implementation, one non-limiting reconciliation procedure is applied block-by-block: (i) clear from FWD[u] any bits that are set in SKIP[u]; (ii) clear from LAT[u] any bits that are set in SKIP[u] or FWD[u]; and (iii) optionally clear from all three region bitsets any bits corresponding to node identifiers in the familiar set S_u (or in another exclusion set), thereby ensuring that region bitsets represent only non-familiar candidate nodes. Equivalent reconciliation procedures that ensure each node identifier appears in at most one region bitset are within the scope of the disclosure.

Deterministic region assignment under precedence. In some embodiments, when a node identifier meets criteria for multiple region categories (e.g., a node is both “lateral” by hop distance and “skipped” as an unmet prerequisite), the node identifier is deterministically assigned to exactly one region category according to the precedence order. This deterministic assignment provides stable behavior across repeated recomputations and supports reproducible audits of why a given node was surfaced to a user.

Trigger conditions for localized recomputation. In some embodiments, the delta-update engine initiates localized recomputation in response to one or more trigger conditions, including: (i) a node's familiarity score crossing a familiarity threshold t in either direction; (ii) a change in a node's shortest-path parent pointer in the user backbone; (iii) addition, deletion, or reweighting of a prerequisite edge in the prerequisite subgraph; and/or (iv) a change in an active dimension-of-interest configuration (e.g., a difficulty scale update or a prerequisite-depth update). The delta-update engine records the trigger condition(s) and the affected node identifiers as update metadata.

Local-neighborhood computation. In some embodiments, the delta-update engine computes a local-neighborhood set N(u) of node identifiers around the affected node identifiers A(u) using one or more bounded graph traversals. By way of non-limiting example, N(u) may include: (i) nodes within a hop distance bound h from any affected node in the base knowledge graph; (ii) prerequisite ancestors of affected nodes up to a depth bound; (iii) prerequisite descendants (dependents) of affected nodes up to a depth bound; and/or (iv) nodes satisfying a lateral-tolerance test relative to one or more familiar nodes. The local-neighborhood set N(u) bounds the scope of recomputation and bounds the set of bit positions that may be set or cleared during delta maintenance.

Delta write format for setting and clearing bits. In some embodiments, updating region bitsets comprises writing one or more delta records that identify bit positions to set and bit positions to clear for a region bitset. A delta record may include: (i) a user identifier; (ii) a region identifier; (iii) a word index or partition identifier; (iv) a set-mask indicating bit positions to set within the addressed word or container; (v) a clear-mask indicating bit positions to clear within the addressed word or container; and (vi) a version tag (e.g., a prior epoch and/or new epoch) enabling idempotent application. When a delta record is applied, the region-bitset store updates the addressed portion of the bitset by setting bits indicated by the set-mask and clearing bits indicated by the clear-mask. In one embodiment, delta records are appended to a log prior to application (write-ahead logging) to support crash recovery and auditability.

Delta maintenance without full-graph scanning. In some embodiments, the delta-update engine computes updated membership only for node identifiers in the local-neighborhood set N(u), and generates deltas for those node identifiers by comparing (i) prior membership state and (ii) recomputed membership state for the neighborhood. The system thereby avoids recomputing region membership for all node identifiers of the knowledge graph in response to each user event.

Partitioned and compressed region bitsets. In some embodiments, the region-bitset store shards region bitsets by ranges of node identifiers (e.g., contiguous ID intervals) or by hash partitions of node identifiers. In such embodiments, the delta-update engine updates only those shards that contain node identifiers in the local-neighborhood set N(u). In some embodiments, one or more region bitsets are stored in a compressed bitset format comprising containers that represent sparse sets, dense sets, and/or ranges of node identifiers. Delta writes in a compressed format may be applied container-by-container, where each delta record identifies the container(s) impacted by the set-mask and clear-mask operations.

Atomicity and consistency across region bitsets. In some embodiments, the region-bitset store applies updates to FWD[u], SKIP[u], and LAT[u] in a manner that preserves the disjointness invariant across partial failures and concurrent updates. By way of non-limiting example, the store may: (i) apply updates under a per-user lock; (ii) apply updates using compare-and-swap on machine words together with a reconciliation pass; and/or (iii) apply updates as a transaction that commits a new epoch identifier for the trio of bitsets. Implementations may also record a snapshot identifier indicating the version of the base knowledge graph against which the bitsets were computed.

Rebuild and verification procedures. In some embodiments, the system periodically verifies or rebuilds per-user region bitsets to prevent drift, for example: (i) by recomputing regions from a consistent snapshot of the familiar set and prerequisite subgraph; (ii) by replaying the delta log for the user from a last-known-good checkpoint; and/or (iii) by sampling a subset of nodes and validating that bitset membership is consistent with the region definitions and precedence rules. These rebuild and verification procedures allow the system to maintain correctness while retaining the latency benefits of localized delta maintenance.

What is claimed is:

1. A computer-implemented method for operating a semantic progression layer over graph-structured data to generate recommendations, the method performed by one or more processors, the method comprising:
(a) initializing a base knowledge graph organized as an ontology of topics and sub-topics, the base knowledge graph comprising nodes and edges;
(b) populating the base knowledge graph with content collected from a plurality of sources;
(c) receiving user input from a user device associated with a user and collecting user-specific data from at least one of the plurality of sources;
(d) creating, for the user, a superposed per-user graph that represents content the user has consumed or is familiar with;
(e) drawing one or more paths in the base knowledge graph between (i) one or more root nodes and (ii) one or more nodes represented in the superposed per-user graph, according to a selected property or dimension of interest;
(f) identifying, relative to the superposed per-user graph and the dimension of interest, at least three progression-related regions comprising:
(i) a forward region comprising nodes beyond what has been explored along the dimension of interest;
(ii) a skipped region comprising nodes that are parent or prerequisite nodes, relative to nodes represented in the superposed per-user graph, and that are not detected among the content the user has consumed or is familiar with; and
(iii) a lateral region comprising nodes neighboring nodes represented in the superposed per-user graph; and
(g) providing one or more recommendations for the user from at least one of the forward region, the skipped region, or the lateral region, and causing display of the one or more recommendations via the digital platform.

2. The method of claim 1, wherein the dimension of interest comprises prerequisite relationships.

3. The method of claim 1, wherein the dimension of interest comprises a difficulty level associated with nodes of the base knowledge graph.

4. The method of claim 1, wherein identifying the skipped region comprises comparing nodes represented in the superposed per-user graph to at least one preceding node in the dimension of interest and labeling the preceding node as skipped when the preceding node is not detected among the content the user has consumed or is familiar with.

5. The method of claim 1, wherein drawing the one or more paths comprises, when the user's history is sparse or fragmented, drawing at least one path from one or more familiar nodes to at least one root node to generate a roadmap for the user.

6. The method of claim 1, further comprising updating at least one of: the superposed per-user graph, the identified forward region, the identified skipped region, the identified lateral region, or the provided recommendations, in response to at least one of: (i) a user login, (ii) a user access of the digital platform, or (iii) a detected user interaction with recommended content.

7. The method of claim 1, wherein populating the base knowledge graph comprises collecting internet-sourced content by at least one of web crawling or accessing one or more application programming interfaces.

8. The method of claim 1, wherein the user-specific data includes at least one of professional data, educational data, social-platform data, health data, or financial data.

9. A system comprising one or more processors and memory storing instructions that, when executed, cause the system to perform the method of claim 1.

10. A non-transitory computer-readable medium storing instructions that, when executed by one or more processors, cause performance of the method of claim 1.

11. A computer-implemented method for maintaining per-user progression-region membership for a semantic progression layer operating over a base knowledge graph, the method performed by one or more processors, comprising:
(a) assigning a stable node identifier to each node of the base knowledge graph;
(b) computing, for a user, a set of familiar nodes based on user-specific interaction signals, the set of familiar nodes comprising nodes for which a familiarity score satisfies a familiarity threshold;
(c) determining, relative to (i) the set of familiar nodes and (ii) at least one dimension of interest defined over nodes of the base knowledge graph, at least three progression-related regions comprising:
(i) a forward region comprising candidate nodes reachable from at least one familiar node along a path that increases according to the dimension of interest;
(ii) a skipped region comprising prerequisite or parent nodes of at least one familiar node that are not in the set of familiar nodes; and
(iii) a lateral region comprising nodes that are within a hop-distance threshold of at least one familiar node and that satisfy a tolerance criterion with respect to the dimension of interest;
(d) storing region membership for the user as:
(i) a forward-region bitset corresponding to the forward region,
(ii) a skipped-region bitset corresponding to the skipped region, and
(iii) a lateral-region bitset corresponding to the lateral region,
wherein each region bitset includes a plurality of bit positions that correspond to the stable node identifiers of the base knowledge graph;
(e) maintaining the forward-region bitset, the skipped-region bitset, and the lateral-region bitset as pairwise disjoint bitsets by applying an exclusion precedence that ensures a stable node identifier is represented in at most one of the region bitsets;
(f) in response to a user event comprising at least one of: (i) an acceptance of a recommendation, (ii) completion of an assessment, (iii) a familiarity score crossing the familiarity threshold, or (iv) a change in shortest-path parentage in a prerequisite-path backbone for the user, updating at least one of the region bitsets by:
(i) identifying a set of affected stable node identifiers for which region membership may have changed;
(ii) computing a local-neighborhood set of stable node identifiers surrounding the affected stable node identifiers; and
(iii) performing delta writes that set or clear bit positions corresponding only to stable node identifiers in the local-neighborhood set, without recomputing region membership for all stable node identifiers of the base knowledge graph; and
(g) providing, to at least one downstream component, at least one progression-related construct derived from at least one of the region bitsets, without requiring that the progression-related construct be a recommendation, the progression-related construct comprising at least one of: (i) at least one of the forward-region bitset, the skipped-region bitset, or the lateral-region bitset; (ii) a candidate-node set identified by set bits in at least one of the region bitsets; or (iii) a ranked list of candidate nodes derived from the candidate-node set, wherein the downstream component is configured to generate one or more progression-related outputs based at least in part on the progression-related construct.

12. The method of claim 11, wherein the stable node identifier for a node remains invariant across updates to node attributes and across successive versioned snapshots of the base knowledge graph.

13. The method of claim 11, wherein the exclusion precedence assigns stable node identifiers to the region bitsets such that skipped-region membership has priority over forward-region membership and such that a union of skipped-region membership and forward-region membership has priority over lateral-region membership.

14. The method of claim 13, wherein applying the exclusion precedence comprises:
(a) inserting into the skipped-region bitset stable node identifiers for nodes in the skipped region, excluding stable node identifiers corresponding to nodes in the set of familiar nodes;
(b) inserting into the forward-region bitset stable node identifiers for nodes in the forward region, excluding stable node identifiers inserted into the skipped-region bitset and excluding stable node identifiers corresponding to nodes in the set of familiar nodes; and
(c) inserting into the lateral-region bitset stable node identifiers for nodes in the lateral region, excluding stable node identifiers inserted into the skipped-region bitset and the forward-region bitset and excluding stable node identifiers corresponding to nodes in the set of familiar nodes.

15. The method of claim 11, wherein the local-neighborhood set is defined by at least one of:
(a) a hop distance in the base knowledge graph from an affected stable node identifier;
(b) ancestor nodes and/or descendant nodes of an affected stable node identifier along prerequisite edges; or
(c) nodes within a lateral tolerance relative to at least one node in the set of familiar nodes.

16. The method of claim 11, wherein performing the delta writes comprises writing one or more delta records that identify bit positions to set and bit positions to clear in at least one of the forward-region bitset, the skipped-region bitset, or the lateral-region bitset.

17. The method of claim 11, wherein each region bitset is stored as an array of machine words, and maintaining the pairwise disjointness comprises performing bitwise operations over blocks of machine words.

18. The method of claim 11, wherein at least one of the region bitsets is stored in a compressed bitset format that stores ranges of stable node identifiers, and the delta writes update the compressed bitset by operating on one or more containers corresponding to the ranges.

19. A system comprising one or more processors and memory storing instructions that, when executed, cause the system to perform the method of claim 11, the system further comprising:
(a) a graph store configured to store the base knowledge graph;
(b) a region-bitset store configured to store the forward-region bitset, the skipped-region bitset, and the lateral-region bitset; and
(c) a delta-update engine configured to perform the delta writes to the region-bitset store in response to the user event,
wherein the system provides, to at least one downstream component, at least one progression-related construct derived from at least one of the region bitsets.

20. A non-transitory computer-readable medium storing instructions that, when executed by one or more processors, cause the one or more processors to perform the method of claim 11.
